(19) United States
(12) Patent Application Publication
(10) Pub. No.: US 2001/0007146 A1
(43) Pub. Date: Jul. 5, 2001

(54) Method for providing a set of software components

(76) Inventors: Uwe Hansmann, Altdorf (DE); Lothar Merk, Weil i.Sch. (DE); Martin S. Nicklous, Stuttgart (DE); Thomas Stober, Boeblingen (DE)

Correspondence Address: Blanche E. Schiller, Esq., HESLIN & ROTHENBERG, P.C., 5 Columbia Circle, Albany, NY, 12203, US

(21) Appl. No.: 09/740,763

(22) Filed: Dec. 19, 2000

(30) Foreign Application Priority Data
Dec. 23, 1999 (EP) 99125771.8

(51) Int. Cl. G06F 17/00

(52) U.S. Cl. 717/10; 709/1

(57) ABSTRACT

The invention relates to a method for providing a set of software components (201, . . . , 206) out of which a software application to be executed by an apparatus (400) comprising processor means and memory means can be partly or entirely assembled.

In order to reduce the memory space for storing said software components in said apparatus it is proposed to assign a different numeric identifier (220, . . . , 225) to each component (201, . . . , 206) of said set of software components, and to store each assigned numeric identifier (220, . . . , 225) in the corresponding component (201, . . . , 206).

### PRIOR FOREIGN APPLICATION

This application claims priority from European patent application number 99125771.8, filed Dec. 23, 1999, which is hereby incorporated herein by reference in its entirety.

### TECHNICAL FIELD

The present invention is generally related to a method for component-oriented software development, particularly of programs in the Java™ program language.

More particularly, the invention relates to a method of software development for devices comprising a small storage capacity and/or processing power, and therefore may comprise only a limited Java Virtual Machine. Such devices may be portable and/or hand-held. Non-limiting examples for such devices are chip cards, Personal Digital Assistants (PDAs) and set-top boxes.

### BACKGROUND OF THE INVENTION

In the following several Java, Java Card and JavaBean specific terms will be used. Further explanations and definitions of the terms are particularly given in the Java Language Specification, such as in the Java Card Language Subset Specification and Virtual Machine Specification, which are made part of this application.

In object-oriented programming programmers do not only define the data type of the data structure, but also the types of operations (functions/methods) that can be applied to the data structure. Accordingly, the data structure becomes an object including both data and methods. Relationships between one object and another can be created, and objects can inherit characteristics from other objects. An important advantage of object-oriented programming techniques in relation to procedural programming techniques is that they allow to create modules that do not need to be changed when a new type of object is added. The new object that inherits features from existing objects can be created by simplified programming. In addition, this allows to modify object-oriented programs more easily.

To perform object-oriented programming an object-oriented programming language (OOPL), such as Java™, C++ or Smalltalk, is needed.

Java is an object-oriented language similar to C++, but simplified to eliminate language features that may cause common programming errors. Java source code files (files with a .java extension) are compiled into a format called bytecode (files with a .class extension), which can then be executed by a Java interpreter. Compiled Java code can be executed on most computers because Java interpreters and runtime environments, known as Java Virtual Machines (JVMs), exist for most operating systems. Bytecode can be converted directly into machine language instructions by a just-in-time compiler (JIT).

Java applications with a certain interface that can run in an internet browser are called Java applets and can be downloaded and executed by a computer comprising a Java Virtual Machine (JVM).

Today's component-oriented software development in Java takes advantage of the so-called JavaBeans architecture. JavaBeans is a specification that defines how the Java objects interact. An object that conforms to this specification is called a JavaBean. Any application that understands the JavaBeans format can use one or more JavaBeans. JavaBeans can be developed only in Java, but can be run on any operating system.

The JavaBeans API (JavaBeans Application Program Interface) makes it possible to write component software in Java. Components are self-contained, reusable software units that can be visually composed into applets or applications using visual application builder tools. A “JavaBeans aware” builder tool maintains JavaBeans in a toolbox. A particular JavaBean from the toolbox can be dropped into a form, its appearance and behaviour may be modified, its interaction with other JavaBeans may be defined, and the JavaBean may be composed with other JavaBeans into an applet, application, or into a new JavaBean. All this can be done without writing a line of code.

Accordingly, the JavaBeans are lightweight and simple modular-programming components for the Java programming language. Their functionality is exposed by an interface, defined by properties, methods, and events. Each JavaBean offers a specific functionality which can be used by applications. Applications understanding the JavaBeans format can examine the JavaBean, evaluate the JavaBeans available properties, methods and events and use the JavaBean. Component-oriented software development in Java™ is assembling an individual application or applet out of common components.

Properties are the JavaBean's appearance and behaviour attributes that can be changed at design time. Properties are exposed to builder tools by design patterns of the so-called JavaBeanInfo class. JavaBeans expose properties so that they can be customized at design time. Customization is supported in two ways: by using property editors, or by using more sophisticated JavaBean customizers.

A JavaBean's methods are no different than Java methods, and can be called from other JavaBeans or a scripting environment. By default all public methods are exported.

JavaBeans use events to communicate with other JavaBeans. A JavaBean that wants to receive events (a listener JavaBean) registers its interest with the JavaBean that fires the event (a source JavaBean). Builder tools can examine a JavaBean and determine which events that JavaBean can fire (send) and which it can handle (receive).

Unfortunately, the promising concept of the JavaBeans is only available in the full Java runtime system, but not within the Java Card system. The problem is, that the common JavaBeans architecture requires to write a number of Java APIs (Java Application Program Interfaces) to be implemented (e.g., Java.lang.reflect).

A Java Card is a smart card or chip card that is capable of running programs or applets written in Java. For this Java platform the Java Card 2.0 API specification is available. The system architecture of a Java Card is illustrated in FIG. 3. Java Card programs or applets are written in Java and compiled using common Java compilers. Due to limited memory resources and computing power in present chip cards, not all the language features defined in the Java language specification are supported on the Java Card. Only the Java Card language subset is available for programming. Specifically, the restricted environment of the Java Card prevents the straightforward inclusion of JavaBeans for the following major reasons:

1. Classes cannot be dynamically loaded onto a Java Card;

2. The JCRE (Java Card Runtime Environment, i.e. of the Java Card Virtual Machine) enforces firewalls because of the special security aspects for chip cards, making the arbitrary sharing of objects between applets more difficult;

3. The String class, used for examination of JavaBean methods, is not available; and

4. The Java.lang.reflect, a Java package, used for run-time examination of a JavaBean, is not available.

### SUMMARY OF THE INVENTION

Accordingly, it is an object of the present invention to provide a method for software development, particularly of software programs in the programming language Java™.

It is another object of the present invention to provide a method for component-oriented software development in the Java programming language for devices comprising a small storage capacity and/or processing power, and therefore they may comprise only a limited Java Virtual Machine (JVM) in relation to a Java Virtual Machine (JVM) supporting all the language features defined in the Java™ language specification.

It is yet another object of the present invention to provide a method for component-oriented software development for portable and/or hand-held devices and to provide portable and/or hand-held devices in which software according to said method is stored.

It is yet a further object of the present invention to provide a method for component-oriented software development in the Java programming language for chip cards, Personal Digital Assistants (PDAs) or set-top boxes and to provide such devices in which software developed according to said method is stored.

### BRIEF DESCRIPTION OF THE DRAWINGS

In the drawings, the same reference signs have been used for the same parts or parts with a similar effect.

FIG. 1 represents a graphical illustration of a Java toolbox comprising JavaBeans allowing component-oriented software development of a transaction program to be executed by a computer comprising a full Java runtime system, according to the prior art;

FIG. 2 shows a Java toolbox according to the present invention comprising so-called MiniBeans allowing component-oriented software development of a transaction program to be executed by a device which may comprise only a limited Java runtime system, according to the invention;

FIG. 3 depicts the software architecture of a Java Card, according to the prior art;

FIG. 4 illustrates the software architecture of a Java Card, according to the invention;

FIG. 5 represents a graphical illustration of the organizational structure shown in FIG. 4 in more detail.

### BEST MODE FOR CARRYING OUT THE INVENTION

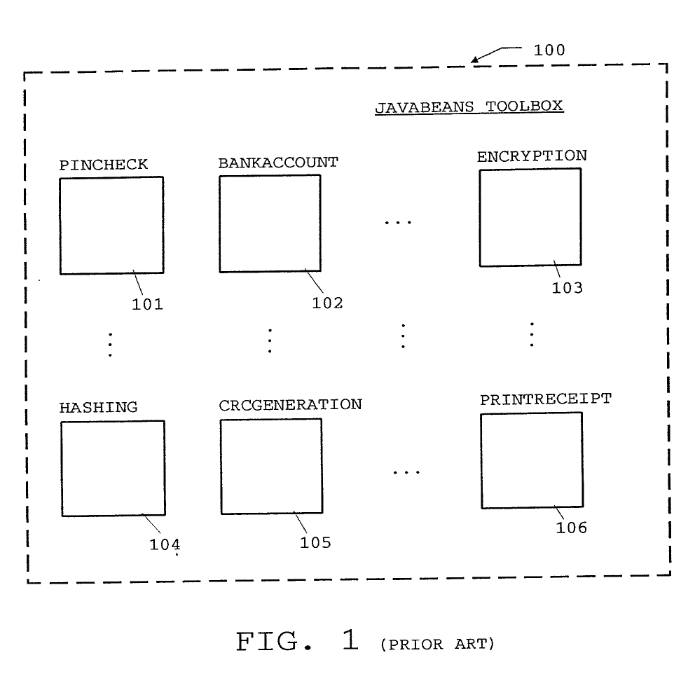

In FIG. 1 a graphical illustration of a known Java toolbox 100 comprising JavaBeans 101 to 106 is depicted. Out of common JavaBeans (components, objects), such as shown in FIG. 1, an individual application or applet may be assembled which can be executed on a computer comprising a full Java runtime system, i.e. a full Java Virtual Machine (JVM). The shown JavaBeans 101 to 106 as well as the JavaBeans indicated by “. . . ” comprise a format which is understood only by a full Java runtime system.

In order to allow a component-oriented software development of a transaction program out of common JavaBeans, the toolbox 100 comprises, among further JavaBeans, a PIN-check-JavaBean 101, a bank-account-JavaBean 102, an encryption-JavaBean 103, a hashing-JavaBean 104, a CRC-generation-JavaBean 105 and a print-receipt-JavaBean 106.

To the JavaBean 101 allowing to perform a PIN check the Bean identifier “PINCHECK” and to the JavaBean 102 allowing to manage a bank account the Bean identifier “BANKACCOUNT” is assigned and stored within the respective JavaBean. The same applies to JavaBean 103 “ENCRYPTION”, JavaBean 104 “HASHING”, JavaBean 105 “CRCGENERATION” and JavaBean 106 “PRINTRECEIPT”.

Hashing is producing hash values for accessing data or for security. A hash value (or simply hash) is a number generated from a string of text. The hash is substantially smaller than the text itself, and is generated by a formula in such a way that it is extremely unlikely that some other text will produce the same hash value.

In security systems they are used to ensure that transmitted messages have not been tampered. The sender generates a hash of the message, encrypts it, and sends it with the message itself. The recipient then decrypts both the message and the hash, produces another hash from the received message, and compares the two hashes. If they are the same, there is a very high probability that the message was transmitted intact.

Hashing is also a common method for accessing data records. Consider, for example, a list of names:

Mike Miller

Alex Beach

Oliver Wade

To create an index, called a hash table, for these records, a formula to each name is applied to produce a unique numeric value. So one might get something like:

1256347 Mike Miller

4758490 Alex Beach

5784921 Oliver Wade

To search for the record containing Alex Beach the formula has to be reapplied, which directly yields the index key to the record.

CRC is the abbreviation of Cyclic Redundancy Check, a common technique for detecting data transmission errors. A number of file transfer protocols, use CRC in addition to a check sum.

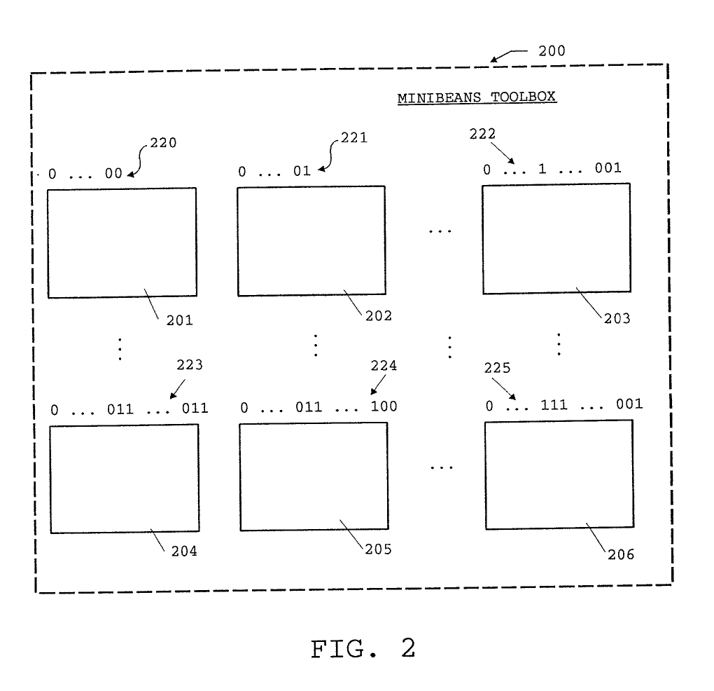

In contrast to FIG. 1, FIG. 2 shows a Java toolbox 200 which comprises so-called MiniBeans 201 to 206 (software components, software objects, software interfaces) whereby the MiniBeans comprise the same or a similar functionality as the JavaBeans shown in FIG. 1, i.e. MiniBean 201 allows to perform a PIN-check, MiniBean 202 allows to manage a bank account etc.

According to an aspect of the present invention the MiniBeans 201 to 206 differ from the JavaBeans 101 to 106 in FIG. 1 in that to each of the MiniBeans 201 to 206 a unique numeric identification element, a numeric identifier, is assigned, which is preferably stored within the respective MiniBean.

Out of the MiniBeans shown in FIG. 2 (and further MiniBeans only indicated by “. . .” in FIG. 2) a Java application or applet may be assembled by means of an appropriate software building tool and the application or applet can be executed on a device or computer comprising a full or a limited Java Virtual Machine (JVM).

The MiniBeans 201 to 206 as well as the indicated MiniBeans define like the known JavaBeans a set of components, i.e. objects, interfaces, for common tasks and to each MiniBean a numerical identifier is assigned. Since there—at least at present—will not be the time or space in a device comprising a low or limited processing power and/or data storage capacity to accommodate runtime method recognition a static method structure for the MiniBeans is used, according to a preferred embodiment of the invention.

Preferably, in order to reduce or minimize the storage space needed in the device to be executed by the application or applet assembled from the MiniBeans, a short numeric identifier is assigned to each MiniBean (component, object, interface). According to a preferred embodiment of the invention, the numeric identifier for each MiniBean is unique with regard to the numeric identifiers of the other MiniBeans in the MiniBeans toolbox 200. Preferably, the short numeric identifier comprises a bit-length of 16 bit.

It will be understood that even a numeric identifier comprising a bit-length of less than 16 bit, such as 8 bit, may be chosen, if the chosen bit-length is sufficient enough to be able to assign a unique numeric identifier or identifying element to each MiniBean in the MiniBeans toolbox 200 comprising a unique function. In contrast, a longer numeric identifier with regard to its bit-length may be chosen, if such longer numeric identifier is needed for a larger number of MiniBeans stored in the toolbox 200 or to be stored in the device.

By assigning a numeric identifier to each of the MiniBeans a set of components (objects, interfaces) is provided out of which an application and/or applet can be partly or entirely assembled. The application and/or applet assembled out of the MiniBeans can be executed by a computer or device comprising a full or a limited Java Virtual Machine.

As shown in FIG. 2 the unique numeric identifier 0 . . . 00 (220) has been assigned to MiniBean 201, the unique numeric identifier 00 . . . 01 (221) to MiniBean 202, the unique numeric identifier 0 . . . 1 . . . 001 (222) to MiniBean 203, the unique numeric identifier 00 . . . 011 . . . 011 (223) to MiniBean 204, the unique numeric identifier 0 . . . 011 . . . 100 (224) to MiniBean 205 and the unique numeric identifier 0 . . . 111 . . . 001 (225) to the MiniBean 206.

It will be understood that the MiniBeans toolbox 200, shown in FIG. 2, is merely a non-limiting example for a set of MiniBeans to assemble a Java application or applet. Obviously, any other program with another functionality than a transaction program can be assembled out of appropriate MiniBeans comprising one or more features according to the present invention.

FIG. 3 shows the software architecture of a known Java Card 300 (chip card, smart card) comprising a microprocessor (not shown), a RAM (not shown), a ROM (not shown) and an EEPROM (not shown) as well as a contact field (not shown) for transmitting data between the Java Card and a card reader/writer (not shown). In one or more of the memories of the Java Card 300 the software code of an operating system and software code allowing the microprocessor to perform native functions 301, of a (limited) Java Card Virtual Machine 302, of a Java Card Framework 303 and of industry add-on classes 304 is stored.

In the ROM of the Java Card 300 an applet A is stored. Applet A is a Java Card program being executable by the (limited) Java Virtual Machine 302. The kind of applet A (305) defines the functions which can be executed by the known Java Card 300.

Due to the limitation of storage space and/or processing power of the known Java Card 300 the number and volume of functions being provided by applet A (305) is low. In addition, it is not possible to modify or update the Java application of applet A, since it is stored partly or entirely in the ROM memory of the known Java Card.

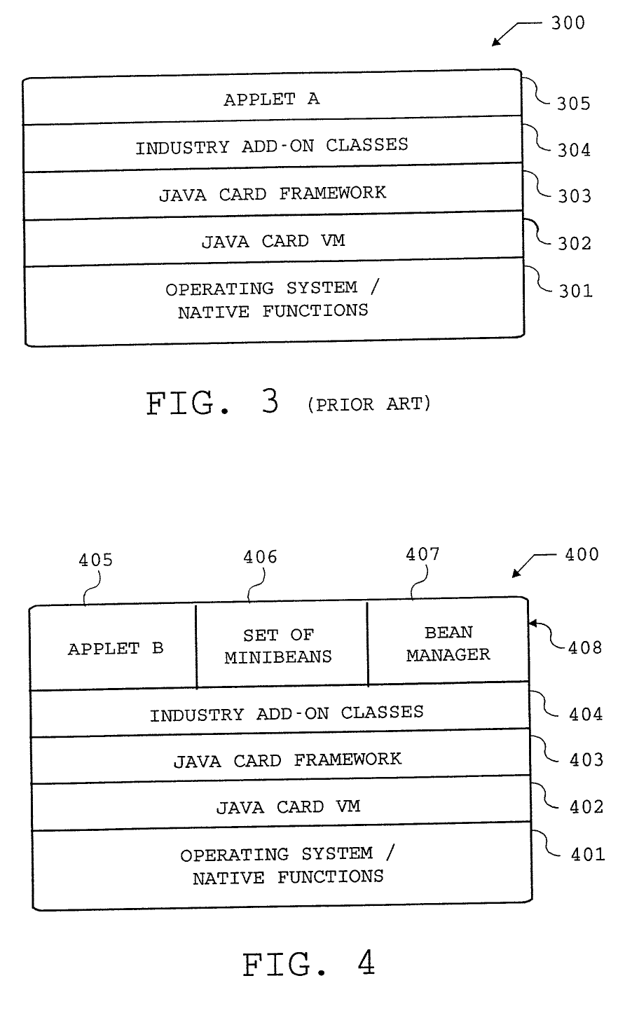

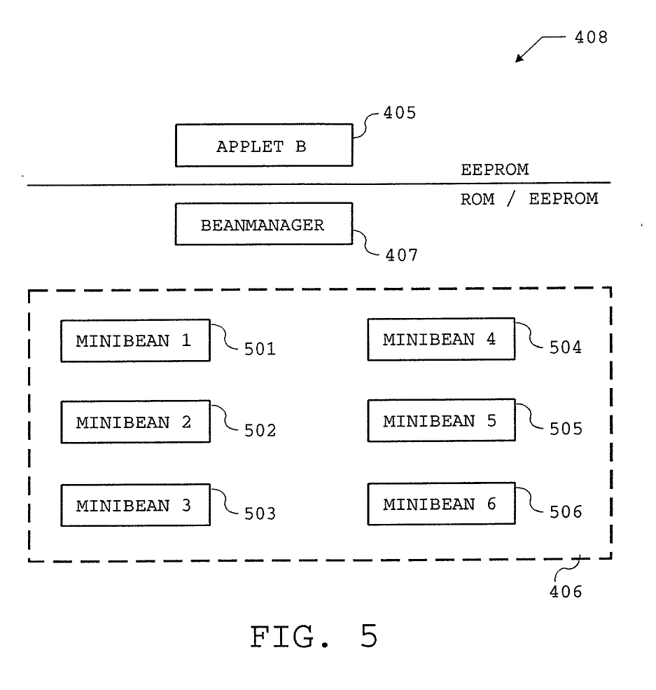

FIG. 4 shows a Java Card 400 according to the invention. The hardware is the same as the hardware of known Java Card 300, shown in FIG. 3, and the software loaded onto the Java Card 400 also comprises an operating system/native functions code 401, a Java Card Virtual Machine 402, a Java Card Framework 403, industry add-on classes 404 and stored in one or more memories of the Java Card 400, like the known Java Card 300.

In contrast, an applet B (405), a set of MiniBeans 406 and a BeanManager 407, i.e. the Java code representing the BeanManager, is stored in one or more memories of the Java Card 400.

FIG. 5 illustrates the organizational structure 408 of applet B (405), the set of MiniBeans 406 and of the BeanManager 407.

In a preferred embodiment of the invention, applet B (405) which is a Java application like applet A (305), is stored in the EEPROM (not shown) of the Java Card 400. The BeanManager 407 and the set of MiniBeans 406, comprising MiniBeans 1 to 6 (501 to 506) in this example, are stored in the ROM (not shown) and/or the EEPROM (not shown) of the Java Card 400.

In another preferred embodiment of the invention, the BeanManager 407 as well as some or all of the MiniBeans 1 to 6 are stored in the EEPROM, in order to obtain the possibility that they can be updated, if necessary.

It will be understood that more or less MiniBeans can be stored in one or more memories of the Java Card 400 of the present invention. The number of MiniBeans stored within the Java Card will be particularly dependent on the number and volume of functions which the specific Java Card is intended to comprise.

According to a preferred embodiment of the invention, several MiniBeans, in this example the MiniBeans 1 to 6, are loaded altogether, preferably also together with applet B (405), into a one or more of the memories of the Java Card 400. The MiniBeans 501 to 506 define one or more numerical interfaces, which are managed by the BeanManager 407.

The BeanManager 407, in a preferred embodiment of the invention loaded together with applet B (405) and MiniBeans 1 to 6 into the Java Card 400, handles instantiation and directory tasks. According to the present invention, the BeanManager is provided with knowledge of all the MiniBeans it is loaded with and/or which are stored in the Java Card 400. Further, the BeanManager 407 is provided with the ability to instantiate the MiniBeans 1 to 6 upon request. A request may particularly come from applet B (405) when applet B (405) controls the Java Card 400 to execute the functions for which the Java Card 400 is programmed.

According to a preferred embodiment of the invention, the BeanManager 407, i.e. its software code, is stored in the EEPROM of the Java Card 400. This particularly, if it is desired that further MiniBeans (not shown) may be added and stored in the Java Card 400. If further or updated MiniBeans (substituting MiniBeans to be updated) are stored within the Java Card 400 an updated version of BeanManager 407 will be loaded to the Java Card 400 and preferably stored within the EEPROM of the Java Card 400. In a preferred embodiment of the invention an updated or additional BeanManager is loaded together with updated and/or additional MiniBeans (not shown) and the updated BeanManager (not shown) replaces or supplements BeanManager 407 and the updated and/or additional BeanManager accounts for any additional or updated MiniBeans.

For simplicity and/or for compatibility with the Java Card security model, these methods are made to be static, in a preferred embodiment of the invention.

By loading all of the MiniBeans, in this example the MiniBeans 1 to 6, together with applet B (405) and preferably also together with BeanManager 407 into the Java Card 400 flexibility is reduced, but storage space is saved because only one BeanManager is needed.

Assume that applet B and applet A comprise the same functions, then by providing the Java Card 400 with a BeanManager 407 and a set of MiniBeans, applet B (405) may be programmed in a easier manner than applet A (305), since all or most of the desired functions to be performed by the Java Card 400 may be provided by the MiniBeans 1 to 6 and made available via the BeanManager 407 upon request of applet B (405). In addition, the organizational structure shown in FIG. 5 allows that applet B (405) and/or one or more of the MiniBeans 1 to 6 (501 to 506) can be updated and/or supplemented in an easy manner. Accordingly, the lifetime of a Java Card and its hardware can be extended. By extending the lifetime of Java Cards (chip cards, smart cards) by one or more of the mentioned measures according to the invention, more expensive Java Cards comprising more storage space and/or processing power than cheaper Java Cards may be given to customers at the same cost per year and thereby even more functions of such Java Cards can be made available.

According to a preferred embodiment of the invention, the BeanManager 407 is provided with the ability to manage partly or entirely the data transfer between the MiniBeans during the execution of a Java program defined by applet B (405), in order to further reduce the storage space needed for the software code to obtain a predefined functionality of the Java Card.

It will be understood that the organizational structure illustrated by the example in FIG. 5 can be implemented in any device comprising a Java Virtual Machine. Particularly this applies, if the functionality of the Java Virtual Machine is limited, such as by limitations of storage space and/or processor power of the device.

In addition, it will be understood that the assignment of numerical identifiers to MiniBeans (objects, components, interfaces like JavaBeans but comprising a format that they can be executed by a limited and/or full Java runtime environment) can be used in application programs and/or software building tools for any device comprising such Java runtime environment.

Non-limiting examples are: chip cards, SIM-Cards (Subscriber Identification Modules-Cards), such as SIM-Cards supporting the SIM Application Toolkit and/or the GSM-, UMTS-protocols, Personal Digital Assistants (PDAs) and set-top boxes.

In the following more detailed information about preferred features of the MiniBeans and the BeanManager, partly defined by Java code, is given. It is to be understood that one or more of these features can be used as alternatives or in addition to one or more of the other features.

Preferably, a MiniBean comprises the following Java method:

static Object makeBean(short interfacID)

This Java routine creates an instantiation of the MiniBean, of the MiniBean's actual type and whether the MiniBean supports the specified interfaceID, i.e. the numeric identifier. If the MiniBean does not support the specified ID, then it returns null. This method is used by the BeanManager to manage a set of MiniBeans, each comprising a different numeric identifier.

Preferably, each MiniBean comprises the following member by which the interface of the corresponding MiniBean, used by the BeanManager, is defined with regard to the BeanManager:

public static final short MINIBEAN INTERFACE_ID

This Java member carries the (preferred) 16-bit value identifying the interface.

A preferred BeanManager comprises the following Java method:

static Object instantiateBean(short[] interfaceIDs)

This Java method throws an exception, if called by an applet, this requests a given interface-instantiation from the BeanManager. The Bean Manager tries to find a MiniBean which supports the requested interface or interfaces, and instantiates one if available and returns it to the applet. Since this method is static, the MiniBean is instantiated in the context of the calling applet.

According to a preferred embodiment of the invention, this single method comprises the entirety of the BeanManager's interface to the outside world, i.e. particularly to one or more applets and to one or more MiniBeans.

The implementation of the BeanManager's instantiateMiniBean routine may comprise the following simple steps, shown in pseudocode:

short x;

Object o=null;

if (interfaceIDs==null) throw Exception(“Wrong argument”);

do {

o=knownBeanType1.makeBean(interfaceIDs);

if (o !=null) break;

o=knownBeanType2.makeBean(interfaceIDs);

if (o !=null) break;

. . .

o=knownBeanTypen.makeBean(interfaceIDs); } while (0);

if (o==null) throw Exception (“Text”);

return o;

Since classes cannot be dynamically loaded onto a Java Card and since the String.class, used for the examination of the JavaBean's methods, is not available, each MiniBean that is to be supported is hard-coded into the BeanManager, according to a preferred embodiment of the invention. However, preferably, only one pair of lines in the “do . . . while”— loop is hard-coded; all intelligence concerning whether or not the interface requested is supported is defined by each MiniBean (see above).

From an applet's point of view, the BeanManager can be described by:

WhatIWantIF if=null;

short [] desiredIDs=new short[] {WHAT I WANT ID };

try {

if=(WhatIWantIF) BeanManager.instantiateBean(desiredIDs);

} catch (Exception e) {;}

if (if==null)//Find a different way to do the task?

Abort?

JavaBeans also include support for properties. Particularly, a property is a private instance variable which has a “getter” method and a “setter” method. These methods are used by visual design tools to manipulate the MiniBean's settings. In their simplest form, properties may be unnecessary for a Java Card—a public variable may be used instead. Advanced properties, however, will need to utilize the “getter/setter” idiom due to the additional operations which must be performed when the variable is accessed.

As an example, for a property called “Foo,” of type X, the following two public methods are preferably implemented:

public X getFoo ();

public void setFoo (X newvalue);

As mentioned before, for simple properties, there is little for these methods to do. (One notable exception is if X is an object type; in this case, getFoo() may wish to return a copy of the object.) Even indexed properties, which are properties whose values are arrays, are straightforward to implement. The interesting part happens when events are implemented, and then tied to properties.

In an embodiment of the invention, inter-applet events (events which are sent to a listener in an applet other than the one in which it was fired) are allowed. However, due to the JCRE's security firewalls, then specific measures have to be taken by means of special code to be inserted into each applet, not just in the MiniBeans themselves. However, the potential benefits may be not as great compared to the effort of implementation.

In a preferred embodiment of the invention, intra-applet events (events which are always delivered within the same applet in which they were fired) are implemented and/or it is proposed to implement the standard Java event mechanism on a Java Card. Advantageously, the mechanism has a well-defined way of excluding the memory expensive multicast events from an implementation if desired.

According to a preferred embodiment of the invention unicast events are used. Unicast events are those where only one listener can register for them. The advantage of unicast events is that the object generating events needs space for only one interface pointer.

Supporting multicast events would require the Java Vector class. Since Java Cards do not support this class (at least presently), according to the invention, one or more of the following interfaces may be used, in order to achieve compatibility with the Java event mechanism:

an EventListener interface (used only for tagging, so it takes minimal space);

an extension of the EventListener interface for each specific event type;

a TooManyListenersException, used for unicast sources (note that this exception need not have any features beyond the normal Exception type).

standardized method names in the event source for registration and deregistration of listener(s)

a special class for each given event (where the event's information is placed)

In addition, according to a preferred embodiment of the invention, an interface for the event source is defined as well. As MiniBeans are only accessed through the interface or interfaces they implement. The event methods could be made part of the MiniBean's main interface, or the MiniBean could implement more than one interface at a time. (This is another argument for allowing the BeanManager to handle request for a MiniBean that can implement multiple interfaces at once).

As an example, let's say we have a MiniBean named PintoBean (used to run the ignition system on a Ford Pinto). This particular MiniBean wants to be able to send events when something changes in the Pinto's running condition. The following new public classes, interfaces, and methods are defined:

class PintoStatusChangedEvent

This class is used to hold all of the data specifying what has changed and how. The data may be stored as private instance variables, and only exposed through accessor methods. For simplicity and space conservation, these safety considerations may be discarded without violating the Java event model. That way, any data in the event can be returned by reference instead of by value, which saves space although not always recommended. This class may extend the EventObject class. However, preferably, the toString () method of that class is not implemented on a Java Card.

interface PintoStatusChangedListener

This would include the single method necessary to receive events from a PintoBean, such as

void pintoStatusChanged(PintoStatusChangedEvent e);

In the PintoBean's interface, the following methods may be added to support registration of listeners:

void addPintoStatusChangedListener

(PintoStatusChangedListener 1) throws TooManyListenersException;

void removePintoStatusChangedListener (PintoStatusChangedListener 1);

Then, when the PintoBean wishes to send an event, it creates a PintoStatusChangedEvent and then passes it to the PintoStatusChanged method in the listener interface-pointer.

If the PintoBean elects to support multicast events (where more than one listener can register), then the TooManyListenersException is preferably not be declared as a thrown exception.

JavaBeans include provisions for two special ways to tie events and properties together—bound properties and constrained properties. These additional abilities can also be implemented on MiniBeans.

The default implementation of these types of properties requires a PropertyChangeListener for the bound properties and a VetoableChangeListener for the constrained properties. However, the standard interfaces for these require one of two things:

The MiniBean accepts registration for a listener, and then passes the name of the changing property with the event that is fired;

or

the MiniBean accepts registration for a listener for a specific property (and then does not pass the name of the property when the event is fired; the listener is expected to know which property it is listening to).

In both cases, a string with the name of the property is passed. According to a preferred embodiment of the invention, to each property a byte identification (ID) number is assigned, which is unique within the interface in which it is defined. This byte-value is passed instead of the corresponding string. The ID value can be defined in a standard way along with each property, as in the following example:

public X getFoo ();

public void setFoo (X newvalue);

public static final byte MINIBEAN_FOO ID=(byte) OxFO;

This does limit each interface to at most 256 bound and/or constrained properties, but within the limited space footprint of a Java Card, this limitation should not be reached in practice.

As will be understood by those skilled in the art, this system does not sacrifice the possibility for use in a visual development tool, although some compromises had to be made, in order to be executable by a limited Java Virtual Machine of a Java Card. However, a properly customized visual development tool can still make use of MiniBeans with one or more of the mentioned features, since:

The BeanManager can be easily machine-generated, based on which MiniBeans it needs to support;

The MiniBeans follow standard naming conventions for event registration, properties, and bound/constrained properties (with the exception of a 8-bit identification (ID) code instead of a string name);

In the case of 8-bit ID codes for property names and 16-bit ID codes for MiniBean interfaces, both may be named with a standard naming convention, i.e. a visual development tool can easily extract and use these ID numbers in its generated code to instantiate and use MiniBeans; and

MiniBeans support off-card MiniBean Customizers, which visually aid the developer in the configuration of the MiniBean but are never loaded or run outside of the development computer and its environment.

Summarized, one major aspect of the invention is to provide a mechanism for a Java Card applet to make use of pre-existing code on the Java Card by only knowing a standardized interface (and its ID number). This fulfills the modular aspect of the JavaBeans design to a high degree with regard to a limited Java Virtual Machine (JVM); the functions wanted must be well-defined at compile time, but the particular object which may provide those functions has not to be defined.

With the described proposals Java application software can be developed in a component-oriented manner, even on small Java devices, which do not fulfill the prerequisites for applying JavaBeans. The MiniBeans can be used to assemble applications out of common components.

Additionally, several solutions are described to use the JavaBeans properties and events abstractions to allow for event-driven operation on a Java Card or another device with a limited Java Virtual Machine (JVM). These ideas can be used independently of the notion of MiniBeans and the BeanManager as well, increasing their usefulness even further.

The flexibility gained by the proposed methods comes at a relatively small code-size cost. The BeanManager is static, compact, and has no state—meaning it need not burn up precious EEPROM resources if no more MiniBeans will be added to the card or device. The MiniBeans it controls are never instantiated until requested, therefore their instance variables do not cause problems. The MiniBeans check themselves for the interfaces they support, but this requires little more than one “for . . . loop” with an if or switch statement in it, and also will not impact code size appreciably; a helper routine for a “common” compatibility check could be placed in the BeanManager for the MiniBeans' benefit.

To a card vendor wishing to create a group of utility functions for programmers to use, the proposed MiniBean interface presents a standardized way to offer these functions to applications, and makes backward-compatibility easy even when a new Java Card with more and different MiniBeans is issued in the future.

Application-builder tools can be customized to work with MiniBeans, enabling developers to very quickly build applets for use on small-scale computing devices, such as smart cards. It also gives a software application developer the flexibility to choose how to handle the absence of a desired piece of functionality at run-time.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What we claim is:

1. A method for providing a set of software components out of which a software application to be executed by an apparatus comprising processor means and memory means can be partly or entirely assembled, said method comprising:
assigning a different numeric identifier to each component of said set of software components; and
storing each assigned numeric identifier in the corresponding component.

2. The method of claim 1, wherein the numeric identifier comprises a bit-length of 8 or 16 bit.

3. The method of claim 1, further comprising loading two or more of said components together in the same step into said memory means of said apparatus, and storing said components therein.

4. The method of claim 3, further comprising:
loading a software application into said apparatus and storing said software application in said memory means;
providing means for instantiating said loaded components upon request of said software application;
loading said means for instantiating into said apparatus; and
storing said means for instantiating in said memory means.

5. The method of claim 1, further comprising providing said apparatus with a full Java Virtual Machine being able to execute every Java instruction.

6. The method of claim 1, further comprising providing said apparatus with a limited Java Virtual Machine being able to execute only certain Java instructions.

7. A system comprising means adapted for carrying out the steps of claim 1.

8. A system comprising means adapted for carrying out the steps of claim 4.

9. A computer program product loadable into memory means of a digital computer, comprising software code for performing the steps of claim 1.

10. A computer program product loadable into memory means of a digital computer, comprising software code for performing the steps of claim 4.

11. A device comprising processor means and memory means, such as a chip card, a Java Card, a set-top box or a Personal Digital Assistant, in which a set of software components is stored, wherein each of said software components comprises a different numeric identifier, preferably comprising a bit-length of 8 or 16 bits.

12. The device of claim 11, further comprising:
a stored software application; and
means for instantiating said software components upon request of said software application.
